(19) United States
(12) Patent Application Publication
(10) Pub. No.: US 2022/0146464 A1
(43) Pub. Date: May 12, 2022

(54) PERFORMING A SEPARATION ON A FIELD FLOW FRACTONATOR

(71) Applicant: Wyatt Technology Corporation, Goleta, CA (US)

(72) Inventor: Steven P. Trainoff, Santa Barbara (US)

(73) Assignee: Wyatt Technology Corporation, Goleta, CA (US)

(21) Appl. No.: 17/502,032

(22) Filed: Oct. 14, 2021

Related U.S. Application Data
(60) Provisional application No. 63/091,906, filed on Oct. 14, 2020.

(51) Int. Cl. G01N 30/00; G05D 7/06

(52) U.S. Cl. CPC G01N 30/0005; G01N 2030/0015; G05D 7/0635

(57) ABSTRACT

The present disclosure describes a method, a system, and a computer program product of performing a separation on a field flow fractionator. In an embodiment, the method, the system, and the computer program product include executing, by a computer system, a set of logical operations measuring a mass flow control valve position of a control valve connected to a mass flow controller coupled to a field flow fractionator and a pressure control valve position of a control valve connected to a pressure controller coupled to the field fold fractionator in an optimal stability state, storing, by the computer system, the valve positions to a data store as preset values, and executing, by the computer system, a set of logical operations retrieving the preset values from the data store and setting initial conditions for the controllers corresponding to the preset values, resulting in a switch mode of the field flow fractionator.

### BACKGROUND

The present disclosure relates to field flow fractionators, and more specifically, to performing a separation on a field flow fractionator.

### SUMMARY

The present disclosure describes a computer implemented method, a system, and a computer program product of performing a separation on a field flow fractionator. In an exemplary embodiment, the computer implemented method, the system, and the computer program product include (1) executing, by a computer system, a set of logical operations measuring a mass flow control valve position of a control valve connected to a mass flow controller coupled to a field flow fractionator and a pressure control valve position of a control valve connected to a pressure controller coupled to the field fold fractionator in an optimal stability state, (2) storing, by the computer system, the valve positions to a data store as preset values, and (3) in response to receiving, by the computer system, a switch mode command, executing, by the computer system, a set of logical operations retrieving the preset values from the data store and setting initial conditions for the controllers corresponding to the preset values, resulting in a switch mode of the field flow fractionator.

In an exemplary embodiment, the computer implemented method, the system, and the computer program product include (1) executing, by a computer system, a set of logical operations determining a focus flow offset value for the field flow fractionator via at least one experiment run on the field flow fractionator, where the focus flow offset value is added to a cross flow value of the field flow fractionator and a detector flow value associated with the field flow fractionator, resulting in a pump flow value for a pump connected to a field flow fractionator.

### DETAILED DESCRIPTION

The present disclosure describes a computer implemented method, a system, and a computer program product of performing a separation on a field flow fractionator. In an exemplary embodiment, the computer implemented method, the system, and the computer program product include (1) executing, by a computer system, a set of logical operations measuring a mass flow control valve position of a control valve connected to a mass flow controller coupled to a field flow fractionator and a pressure control valve position of a control valve connected to a pressure controller coupled to the field fold fractionator in an optimal stability state, (2) storing, by the computer system, the valve positions to a data store as preset values, and (3) in response to receiving, by the computer system, a switch mode command, executing, by the computer system, a set of logical operations retrieving the preset values from the data store and setting initial conditions for the controllers corresponding to the preset values, resulting in a switch mode of the field flow fractionator. In an embodiment, the switch mode is one of a focus mode, an elution mode, a focus injection mode, and an elution inject mode. In an embodiment, FIG. 4A depicts the computer implemented method. The results of running the computer implemented method, the system, and the computer program product are shown in the two right hand side graphs of FIG. 2, with the upper trace in the upper right hand corner of FIG. 2 indicating a goal of a setpoint and the lower trace in the lower trace in the upper right hand corner of FIG. 2 indicating an actual setpoint achieved by the computer implemented method, the system, and the computer program product.

In an exemplary embodiment, the computer implemented method, the system, and the computer program product include (1) executing, by a computer system, a set of logical operations determining a focus flow offset value for the field flow fractionator via at least one experiment run on the field flow fractionator, where the focus flow offset value is added to a cross flow value of the field flow fractionator and a detector flow value associated with the field flow fractionator, resulting in a pump flow value for a pump connected to a field flow fractionator. In an embodiment, FIG. 4B depicts the computer implemented method. The results of running the computer implemented method, the system, and the computer program product, are shown in the upper data trace in FIG. 3.

### Focus Flow Offset

In an embodiment, the determining the focus flow offset value includes: (brute force) (a) executing, by a computer system, a set of logical operations generating a plurality of candidate focus flow offset values, (b) executing, by a computer system, a set of logical operations adding each of the candidate focus flow offset values to the cross flow value and the detector flow value, (c) executing, by a computer system, a set of logical operations measuring a time for a detector flow associated with the field flow fractionator to equilibrate corresponding to the each of the candidate focus flow offset values, resulting in a detector flow equilibration time associated with the field flow fractionator corresponding to the each of the candidate focus flow offset values; and (d) executing, by a computer system, a set of logical operations identifying the focus flow offset value as a candidate focus flow offset value among the plurality of candidate focus floc offset values corresponding to a minimum value of the detector flow equilibration time.

In an embodiment, the determining the focus flow offset value includes (a) executing, by a computer system, a set of logical operations setting the focus flow offset value to an initial value (e.g., 0 mL/min), resulting in an initial focus flow offset value, (b) executing, by a computer system, a set of logical operations adding the initial focus flow offset value to the cross flow value and the detector flow value, (c) executing, by a computer system, a set of logical operations measuring a steady state channel pressure of the field flow fractionator in a focus mode, P_{f}, (d) executing, by a computer system, a set of logical operations measuring a steady state channel pressure of the field flow fractionator in an elution mode, Pₑ, (e) executing, by a computer system, a set of logical operations calculating a new focus flow offset value for the field flow fractionator over n iterations by

F_{o,n+1}=F_{o,n}+(1−P_{f,n}/Pₑ)F_{d},

where F_{o,n} is a focus flow offset value at iteration/step n, where P_{f,n} is a channel flow of the field flow fractionator in the focus mode at iteration/step n, and where Pₑ is a channel pressure of the field flow fractionator in the elution mode at iteration/step n, and (f) executing, by a computer system, a set of logical operations setting the focus flow offset value to the new focus flow offset corresponding to P_{f,n}=Pₑ.

In an exemplary embodiment, the computer system is a standalone computer system, such as computer system 500 shown in FIG. 5, a network of distributed computers, where at least some of the computers are computer systems such as computer system 500 shown in FIG. 5, or a cloud computing node server, such as computer system 500 shown in FIG. 5. In an embodiment, the computer system is a computer system 500 as shown in FIG. 5, that executes an indicating a status of an analytical instrument on a screen of the analytical instrument script or computer software application that carries out the operations of at least the method. In an embodiment, the computer system is a computer system/server 512 as shown in FIG. 5, that executes an indicating a status of an analytical instrument on a screen of the analytical instrument script or computer software application that carries out the operations of at least the method. In an embodiment, the computer system is a processing unit 516 as shown in FIG. 5, that executes an indicating a status of an analytical instrument on a screen of the analytical instrument script or computer software application that carries out the operations of at least the method.

In an embodiment, the computer system is a computer system 500 as shown in FIG. 5, that executes a deducing sizes of nanoparticles script or computer software application that carries out at least operations of at least the method. In an embodiment, the computer system is a computer system/server 512 as shown in FIG. 5, that executes a deducing sizes of nanoparticles script or computer software application that carries out at least operations of at least the method. In an embodiment, the computer system is a processing unit 516 as shown in FIG. 5, that executes a deducing sizes of nanoparticles script or computer software application that carries out at least operations of at least the method. In an embodiment, the computer system is a machine learning computer software/program/algorithm that executes a deducing sizes of nanoparticles script or computer software application that carries out the operations of at least the method.

### Computer System

In an exemplary embodiment, the computer system is a computer system 500 as shown in FIG. 5. Computer system 500 is only one example of a computer system and is not intended to suggest any limitation as to the scope of use or functionality of embodiments of the present invention. Regardless, computer system 500 is capable of being implemented to perform and/or performing any of the functionality/operations of the present invention.

Computer system 500 includes a computer system/server 512, which is operational with numerous other general purpose or special purpose computing system environments or configurations. Examples of well-known computing systems, environments, and/or configurations that may be suitable for use with computer system/server 512 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 512 may be described in the general context of computer system-executable instructions, such as program modules, being executed by a computer system. Generally, program modules may include routines, programs, objects, components, logic, and/or data structures that perform particular tasks or implement particular abstract data types. Computer system/server 512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 512 in computer system 500 is shown in the form of a general-purpose computing device. The components of computer system/server 512 may include, but are not limited to, one or more processors or processing units 516, a system memory 528, and a bus 518 that couples various system components including system memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 512 typically includes a variety of computer system readable media. Such media may be any available media that is accessible by computer system/server 512, and includes both volatile and non-volatile media, removable and non-removable media.

System memory 528 can include computer system readable media in the form of volatile memory, such as random access memory (RAM) 530 and/or cache memory 532. Computer system/server 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions/operations of embodiments of the invention.

Program/utility 540, having a set (at least one) of program modules 542, may be stored in memory 528 by way of example, and not limitation. Exemplary program modules 542 may include an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the present invention.

Computer system/server 512 may also communicate with one or more external devices 514 such as a keyboard, a pointing device, a display 524, one or more devices that enable a user to interact with computer system/server 512, and/or any devices (e.g., network card, modem, etc.) that enable computer system/server 512 to communicate with one or more other computing devices. Such communication can occur via Input/Output (I/O) interfaces 522. Still yet, computer system/server 512 can communicate with one or more networks such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples, include, but are not limited to: microcode, device drivers, redundant processing units, external disk drive arrays, RAID systems, tape drives, and data archival storage systems.

### Computer Program Product

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer implemented method comprising:
executing, by a computer system, a set of logical operations measuring a mass flow control valve position of a control valve connected to a mass flow controller coupled to a field flow fractionator and a pressure control valve position of a control valve connected to a pressure controller coupled to the field fold fractionator in an optimal stability state;
storing, by the computer system, the valve positions to a data store as preset values; and
in response to receiving, by the computer system, a switch mode command, executing, by the computer system, a set of logical operations retrieving the preset values from the data store and setting initial conditions for the controllers corresponding to the preset values, resulting in a switch mode of the field flow fractionator.

2. The method of claim 1 wherein the switch mode is one of a focus mode, an elution mode, a focus injection mode, and an elution inject mode.

3. A computer implemented method comprising:
executing, by a computer system, a set of logical operations determining a focus flow offset value for the field flow fractionator via at least one experiment run on the field flow fractionator,
wherein the focus flow offset value is added to a cross flow value of the field flow fractionator and a detector flow value associated with the field flow fractionator, resulting in a pump flow value for a pump connected to a field flow fractionator.

4. The method of claim 3 wherein the determining the focus flow offset value comprises:
executing, by a computer system, a set of logical operations generating a plurality of candidate focus flow offset values;
executing, by a computer system, a set of logical operations adding each of the candidate focus flow offset values to the cross flow value and the detector flow value;
executing, by a computer system, a set of logical operations measuring a time for a detector flow associated with the field flow fractionator to equilibrate corresponding to the each of the candidate focus flow offset values, resulting in a detector flow equilibration time associated with the field flow fractionator corresponding to the each of the candidate focus flow offset values; and
executing, by a computer system, a set of logical operations identifying the focus flow offset value as a candidate focus flow offset value among the plurality of candidate focus floc offset values corresponding to a minimum value of the detector flow equilibration time.

5. The method of claim 3 wherein the determining the focus flow offset value comprises:
executing, by a computer system, a set of logical operations setting the focus flow offset value to an initial value (e.g., 0 mL/min), resulting in an initial focus flow offset value;
executing, by a computer system, a set of logical operations adding the initial focus flow offset value to the cross flow value and the detector flow value;
executing, by a computer system, a set of logical operations measuring a steady state channel pressure of the field flow fractionator in a focus mode, P_{f};
executing, by a computer system, a set of logical operations measuring a steady state channel pressure of the field flow fractionator in an elution mode, Pₑ; and
executing, by a computer system, a set of logical operations calculating a new focus flow offset value for the field flow fractionator over n iterations by
F_{o,n+1}=F_{o,n}+(1−P_{f,n}/Pₑ)F_{d},
wherein F_{o,n} is a focus flow offset value at iteration/step n,
wherein P_{f,n} is a channel flow of the field flow fractionator in the focus mode at iteration/step n, and
Pₑ is a channel pressure of the field flow fractionator in the elution mode at iteration/step n; and
executing, by a computer system, a set of logical operations setting the focus flow offset value to the new focus flow offset corresponding to P_{f,n}=Pₑ.

6. A system comprising:
a memory; and
a processor in communication with the memory, the processor configured to perform a method comprising
executing a set of logical operations measuring a mass flow control valve position of a control valve connected to a mass flow controller coupled to a field flow fractionator and a pressure control valve position of a control valve connected to a pressure controller coupled to the field fold fractionator in an optimal stability state,
storing the valve positions to a data store as preset values, and
in response to receiving a switch mode command, executing a set of logical operations retrieving the preset values from the data store and setting initial conditions for the controllers corresponding to the preset values, resulting in a switch mode of the field flow fractionator.

7. A computer program product comprising a computer readable storage medium having program instructions embodied therewith, the program instructions executable by a processor to cause the processor to perform a method comprising:
executing a set of logical operations measuring a mass flow control valve position of a control valve connected to a mass flow controller coupled to a field flow fractionator and a pressure control valve position of a control valve connected to a pressure controller coupled to the field fold fractionator in an optimal stability state;
storing the valve positions to a data store as preset values; and
in response to receiving a switch mode command, executing a set of logical operations retrieving the preset values from the data store and setting initial conditions for the controllers corresponding to the preset values, resulting in a switch mode of the field flow fractionator.

8. A system comprising:
a memory; and
a processor in communication with the memory, the processor configured to perform a method comprising
executing a set of logical operations determining a focus flow offset value for the field flow fractionator via at least one experiment run on the field flow fractionator,
wherein the focus flow offset value is added to a cross flow value of the field flow fractionator and a detector flow value associated with the field flow fractionator, resulting in a pump flow value for a pump connected to a field flow fractionator.

9. A computer program product comprising a computer readable storage medium having program instructions embodied therewith, the program instructions executable by a processor to cause the processor to perform a method comprising:
executing a set of logical operations determining a focus flow offset value for the field flow fractionator via at least one experiment run on the field flow fractionator,
wherein the focus flow offset value is added to a cross flow value of the field flow fractionator and a detector flow value associated with the field flow fractionator, resulting in a pump flow value for a pump connected to a field flow fractionator.
